(19) United States
(12) Patent Application Publication
(10) Pub. No.: US 2015/0106826 A1
(43) Pub. Date: Apr. 16, 2015

(54) APPARATUS FOR SERVICING AT LEAST ONE FIELD DEVICE OF AUTOMATION TECHNOLOGY

(71) Applicant: Endress + Hauser Process Solutions AG, Reinach (CH)

(72) Inventors: Jorg Hahniche, Bad Krozingen (DE); Immanuel Vetter, Sinzheim (DE); Julien Messer, Grentzingen (FR); Frank Birgel, Schopfheim (DE); Tobias Horn, Altdorf (DE)

(21) Appl. No.: 14/362,646

(22) PCT Filed: Nov. 22, 2012
(86) PCT No.: PCT/EP2012/073309

§ 371 Date: Jun. 4, 2014

(30) Foreign Application Priority Data
Dec. 6, 2011 (DE) 10 2011 087 826.2

(51) Int. Cl. G06F 13/10; G06F 9/54

(52) U.S. Cl. CPC G06F 13/102; G06F 9/54
USPC 719/321

(57) ABSTRACT

An apparatus for servicing at least one field device of automation technology by means of a servicing unit connected or connectable with the field device, wherein a server arranged outside of the field device is associated with the servicing unit, wherein the server provides field device type specific web pages for the respective field devices, and wherein there is associated with the servicing unit a servicing program, which provides a browser, in order to present the field device type specific web pages on a display unit and which provides a communication link between the server and the field device for the purpose of servicing the field device.

The invention relates to an apparatus for servicing at least one field device of automation technology by means of a servicing unit connected or connectable with the field device.

In automation technology, especially in process, as well as in manufacturing, automation technology, field devices are often applied, which serve for registering and/or influencing physical, chemical or biological, process variables. Serving for registering process variables are measuring devices, such as, for example, fill level measuring devices, flow measuring devices, pressure and temperature measuring devices, pH measuring devices, conductivity measuring devices, etc., which register the corresponding process variables, fill level, flow, pressure, temperature, pH-value, and conductivity, respectively. Used for influencing process variables are actuators, such as valves or pumps, via which e.g. the flow of a liquid in a pipeline or the fill level of a medium in a container is changed. The terminology ‘field devices’ as used in connection with the invention, thus, includes all types of measuring devices and actuators.

Referred to as field devices in connection with the invention are, moreover, also all devices, which are applied near to the process and deliver or process information relevant to the process. Besides the earlier named measuring devices/sensors and actuators, also referred to as field devices are generally such units, which are connected directly to a fieldbus and serve for communication with the superordinated unit. Thus also categorized as field devices are units such as e.g. remote I/Os, gateways, linking devices and wireless adapters, respectively radio adapters. A large number of such field devices are produced and sold by the Endress+Hauser group of companies.

In modern industrial plants, communication between at least one superordinated control unit and the field devices occurs, as a rule, via a bus system, such as, for example, the Profibus® PA, Foundation Fieldbus® or HART® bus system. The bus systems can be embodied both wired as well as also wirelessly. The superordinated control unit serves for process control, process visualizing, process monitoring and/or start-up and servicing of the field devices and is also referred to as a configuration/management system.

The integration of field devices into configuration—or management systems can occur via device descriptions, which care therefor, that the superordinated control units, respectively servicing units, can detect and interpret the data delivered by the field devices. As a rule, the respective device manufacturers provide the device descriptions for each field device type, in given cases, for each field device type in different applications. In order that the field devices can be integrated in different fieldbus systems, different device descriptions for the different fieldbus systems must be created. Thus there are—to name only a few examples—HART, Fieldbus Foundation and Profibus device descriptions. The number of device descriptions is very large—corresponding to the large number of different field devices, respectively field device types, in different applications and bus systems.

For the purpose of creating a universal description language for field devices, the Fieldbus Foundation (FF), the HART Communication Foundation (HCF) and the Profibus User Organization (Profibus Nutzerorganisation or PNO) have created a unified electronic device description language (Electronic Device Description Language EDDL). The EDDL, respectively the corresponding Electronic Device Description EDD, is defined in the standard, IEC 61804-2.
Besides the above described device descriptions, so-called Device Type Managers (DTM), respectively device managers or device drivers, are applied, which require as runtime environment a suitable frame application, especially an FDT frame. DTMs serve for comprehensive servicing of field devices and correspond to the FDT—Field Device Tool—specification. The FDT specification, as an industrial standard, is an interface specification and was developed by PNO—Profibus User Organisation—in cooperation with ZVEI—Zentralverband Elektrotechnik—and Elektroindustrie (German Electrical and Electronic Manufacturers' Association). The respectively current FDT specification is obtainable from the ZVEI, respectively the PNO, respectively the FDT Group. The FDT technology brought the opportunity for universal servicing of field devices of different manufacturers via device drivers, which describe the field devices comprehensively and are runnable in an FDT frame application (FDT frame). The terminology, servicing of field devices, means quite generally the parametering or configuration of field devices, as well as performing diagnosis of field devices or inquiring of their status. In the simplest case, the servicing of a field device means representing information concerning the field device on a display.

Since for each field device type a corresponding field device specific, device driver DTM (Device Type Manager), respectively a corresponding field device specific, device description DD (Device Description), is required, the number of required field device type specific descriptions is very large. One speaks in this connection of a device driver/device description library. Via an installed setup of the library, it is possible for a customer universally to service field devices of different manufacturers.

The known solution is disadvantageous in the following ways:
There is always a direct dependency between the device type and the device driver, respectively the device description;
For servicing the field device, a specific associating of the device driver with the field device must be performed;
In order to keep the host, e.g. the servicing unit, up to date, an updating of the device drivers, respectively the device descriptions, must be performed.
The making of new installations as well as the updating of already installed device drivers, respectively device descriptions, are both time consuming activities.

Moreover, it is also known to integrate in a field device a web server, via which e.g. a parametering/configuring of the field device or a diagnosis of the field device can be performed. Depending on available memory capacity in the field device, this function is more or less well supported. An advantage of a web server in the field device is that the installation and updating of device drivers, respectively device descriptions, at the host, e.g. the servicing unit, can be omitted, since a standard operating means, thus especially a web browser, is used.

However, the solution with a web server in the field device has also less advantageous aspects:
Not all field devices support a web server, since either no memory capacity or insufficient memory capacity is available;
Also, the degree of support of the web server differs, especially when the available memory capacity is limited;
There is a dependency between the web browser, respectively the web server, and the supported HTML standard. Problems occur, when the web server in the field device is not compatible with the web browser, respectively when the web browser is not supported by the web server;
A processing of the device data without accessing an existing device is not possible, since the therefor required web server of a fitting device must be provided. Thus, some application scenarios, above all, in the engineering domain, are not supported.

An object of the invention is to provide an apparatus, which simplifies the servicing of field devices of automation technology by means of a servicing unit.

The object is achieved by features including that: a server arranged outside of the field device is associated with the servicing unit; the server dynamically produces at least one field device type specific, web page (or, in general, a field device specific content) for the respective field device; and that there is associated with the servicing unit a servicing program, which provides a browser, in order to present the field device type specific web page, respectively the field device specific content, on a display unit. Furthermore, the servicing program provides, respectively directly produces, a communication link between the server and the field device for the purpose of servicing the field device. Preferably, the servicing unit is a mobile servicing device, e.g. a smart phone, a laptop, a PDA or some other handheld servicing device. The concept “field device” has already been explained above.

In a preferred embodiment of the apparatus of the invention, the servicing program, which provides the web browser, is implemented as device managers in a suitable frame application. Furthermore, a communication driver is provided, which establishes the communication link to the respective field device. The linking occurs either via a service interface or via a fieldbus interface. The device driver is preferably a device driver FDT-DTM produced corresponding to the FDT standard. The frame application is, in this case, an FDT frame, in which the FDT device drivers are runnable.

An advantageous embodiment of the apparatus of the invention provides that the servicing program works offline and is so embodied that produced in the web server are instance specific data sets, which are matched to a virtual field device, thus a not connected field device, and which completely describe the field device in the provided application.

Furthermore, the servicing program is so embodied that the instance specific data sets can be read-out from the web server and written back, without there being a direct connection with a corresponding field device.

Alternatively, it is provided that the servicing program works online and is so embodied that, in the case of connected field device, the servicing program commands the web server to conform, by reading from or writing to the field device, the, in given cases, earlier offline produced data sets at least partially with the data sets present in the field device. To do this, the servicing program establishes the required communication link. Moreover, it is provided, in this connection, that the servicing program is so embodied that the web server in the case of connected field device communicates via the offered communication link with the field device, displays field device specific information in the at least one web page and enables a servicing of the field device.

Preferably, the communication between the servicing unit and the server occurs via an intranet- and/or an Internet connection.

Advantages of the invention compared with the solution with web server integrated in the field device are the following:
The field device specific device description is not installed in the host, here thus the servicing device, but, instead, is provided “on demand” directly from a connected web server or via Internet/intranet from a web server “in the cloud”.
The HTML pages are provided not only by the field device, but, instead, also and supplementally from a decentrally or locally arranged web server with standard Internet services.
The web browser is—such as described in the case of the preferred embodiment—embedded in the servicing device in a device driver and in a frame application designed for the device driver, e.g. the FDT frame.
Just a standard device driver DTM is required, in which the web browser is embedded.
Communication with the field device is enabled by means of the communication driver. In online operation, the corresponding information, especially the parameters, the calibration data, the diagnostic values, etc. in the field device, can be accessed directly either by means of a web server in the field device or by means of an external web server.

The terminology, online, means in connection with the invention that the field device specific data sets of the field device are provided as soon as the connection between the servicing unit and the field device is produced. Then, the edited, instance specific, data sets matched to the particular application, involving especially parameter values, diagnostic values, status values, etc., can be stored locally or decentrally in a section of a memory.

In contrast to this, offline operation means that the field device type specific data sets are provided either locally or decentrally, processed offline, and, thus, produced as instance specific data sets, thus data sets tailored to the particular application, and then stored as instance specific data sets.

The relationship between parameters stored in the field device and those in the HTML page is determined in the web server by the device model of the respective field device type.

The advantages of the invention are again summarized here:
Field devices, which support no web server—so-called legacy devices—can be serviced by means of the web browser, thus especially parametered or configured, as well as diagnosed.
There is no dependency between the field device and the web browser, respectively the HTML technology.
No additional resources (especially memory resources) are required in the field devices. In this way, it is possible according to the invention to service field devices already installed in an automation plant. The same holds for field devices already equipped with a web server.
There is no installation of a library of device drivers or devices descriptions in the servicing unit. To this point in time, it has been necessary to install these complexly in the host, in order, depending on need, to have available the corresponding field device specific device drivers, respectively (i.e. or, and, and/or) device descriptions for servicing the field devices.
Updates of device descriptions, respectively device drivers, are only performed in the web server. If a decentral, Internet accessible, web server is used, then this automatically provides always the currently valid HTML pages for the field devices to be serviced.
A central update server can be applied, in order at any desired point in time to update distributed web servers and, for example, to tend the library of device descriptions.

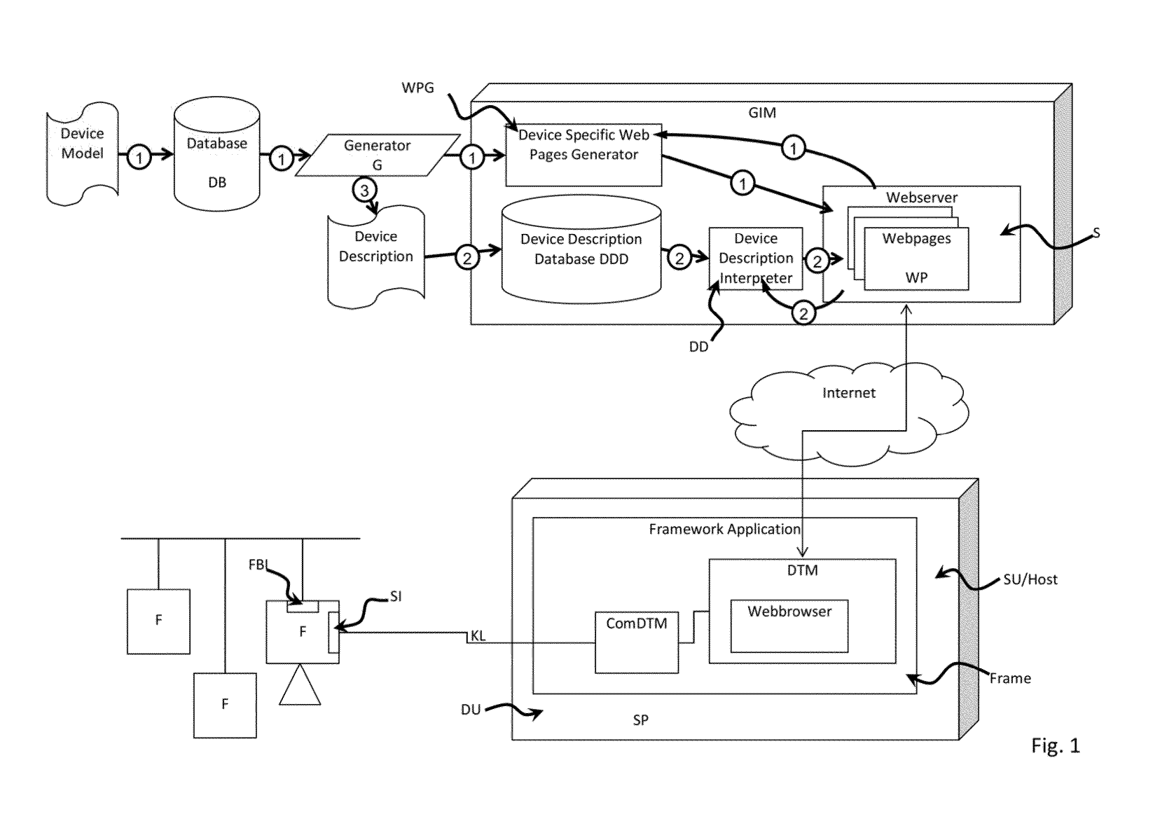

The invention will now be explained in greater detail based on the sole figure of the drawing, FIG. 1.

FIG. 1 is a schematic representation of the apparatus of the invention for servicing at least one field device F of automation technology.

The terminology, field devices, has already been explained above. Field device F is arranged, for example, in an automation plant. In the illustrated case, the field device F includes a fieldbus interface FBI and a service interface SI. Via the service interface SI, the field device F in the shown example is connected with a servicing unit SU; the field device F is thus online. Communication occurs either via suitable connecting cable or via radio. Via the fieldbus interface FBI, the field device F is coupled e.g. with one of the fieldbusses customary in automation technology and communicates via one of the communication protocols, which were already named above, with a control/servicing unit (not separately illustrated).

The servicing unit SU is connected with a server S arranged outside of the field device, F. In the illustrated case, the server S is reachable via Internet. Provided, however, is also a direct connection between field device F and server S. Server S provides on a web page WP, upon corresponding query, at least one piece of field device type specific information for the respective field device F. This information corresponds e.g. to at least one part of the parameters, which describe the field device F and its functionality. The information can, however, also be status information or diagnostic information.

According to the invention, the service program SP associated with the servicing unit SU provides a browser B. This makes the field device type specific web pages WP available on a display unit DU. Furthermore, the servicing unit SU provides a communication link KL between the server S and the field device F. The servicing of the field device F occurs via this communication link KL.

In the left upper region of FIG. 1, three different cases are schematically presented for how the web pages WP provided by a server DIM—Device Integration Manager—can, by way of example, be produced:
1. Collected in a database DB is information available for the individual field devices F. The information concerns static information for the field devices F, such as texts, in given cases, in different languages, however, also complex device models with algorithms, respectively the business logic of the field device F, which takes into consideration the mutual dependencies of the individual parameters describing the field device F, as well as device type specific, implementation information. Via corresponding generators G, based on the information stored in the database DB for the individual field devices F, field device specific web page generators WPG are created. The field device specific web page generator WPG associated with a field device F is utilized by the web server S, in order to generate the web pages WP for the servicing.
2. A device description DD, in the case of which such involves e.g. the already earlier described device description DD, is loaded into the device description database DDD of the server DIM. The device description-interpreter DDI is utilized by the web server S, in order to produce field device specific web pages WP for the field device F.
3. The device model is stored within a database DB. Instead of producing web page generators WPG with the generator G, here a device description DD is created, which then utilizes the interpreter DDI, in order to produce web pages WP for the web server S.

The selection of a field device F occurs, in each case, via a unique device ID. Depending on application, this is, for example, the serial number, the device tag or even the device type.

Not shown in FIG. 1 is the case, in which the field device F can include an additional web server, i.e. its own web server. This web server contains essentially only the components required for presenting web pages corresponding to the field device F. The production of the web pages WP occurs with the means described for the web server S in the server DIM. The accessing of the web pages occurs via the communication link KL and e.g. the service interface SI.

1-7. (canceled)

8. An apparatus for servicing at least one field device of automation technology by means of:
a servicing unit connected or connectable with the field device;
a server arranged outside of the field device which is associated with said servicing unit;
said server provides field device type specific web pages for the respective field devices; and
is associated with said servicing unit a servicing program, which provides a browser, in order to present the field device type specific web pages on a display unit, and which provides a communication link between said server and the field device for the purpose of servicing the field device.

9. The apparatus as claimed in claim 8, wherein:
said servicing program, which provides the web browser, is implemented as device managers in a frame application (FRAME), especially an FDT frame application; and
a communication driver is provided, which establishes the communication linking to the respective field device.

10. The apparatus as claimed in claim 8, wherein:
said servicing program works offline and is so embodied that produced in said web server is at least one instance specific data set, which is matched to a virtual field device and which completely describes the field device in the provided application; and
said data set is edited, read-out by said web server and written back, without there being a direct connection with a corresponding field device.

11. The apparatus as claimed in claim 8, wherein:
said servicing program works online and is so embodied that, in the case of connected field device, it commands said web server to conform the offline produced data sets at least partially with the field device via the communication link provided by said servicing program by reading the data sets from or writing the data sets to the field device (F).

12. The apparatus as claimed in claim 8, wherein:
said servicing program is so embodied that said web server in the case of connected field device communicates with the field device via the offered communication link and displays field device specific information in said web pages.

13. The apparatus as claimed in claim 8, wherein:
said servicing unit and the server communicate with one another via an intranet- and/or an Internet connection.

14. The apparatus as claimed in claim 8, wherein:
said servicing unit is a mobile servicing device.
